(19) United States
(12) Patent Application Publication
(10) Pub. No.: US 2024/0326862 A1
(43) Pub. Date: Oct. 3, 2024

(54) TRAVELING TRAJECTORY GENERATING APPARATUS

(71) Applicant: Mitsubishi Electric Corporation, Tokyo (JP)

(72) Inventor: Rin ITO, Tokyo (JP)

(73) Assignee: Mitsubishi Electric Corporation, Tokyo (JP)

(21) Appl. No.: 18/577,710

(22) PCT Filed: Jul. 20, 2021
(86) PCT No.: PCT/JP2021/027186

§ 371 Date: Jan. 9, 2024

(51) Int. Cl. B60W 60/00

(52) U.S. Cl. CPC B60W 60/001; B60W 2710/20; B60W 2720/106

(57) ABSTRACT

The present disclosure relates to a traveling trajectory generating apparatus that generates a traveling trajectory of a vehicle and that includes: a reference value storage to store, as a plurality of preceding reference values, a plurality of reference values including information on a state of the vehicle, the information being referred to when the traveling trajectory generating apparatus generates the traveling trajectory; a reference value calculator to calculate a plurality of current reference values, based on at least the plurality of preceding reference values and a target state that is a target value of a vehicle state quantity of the vehicle, the plurality of current reference values being referred to when the traveling trajectory generating apparatus generates the traveling trajectory in a current computation period; and a trajectory generator to generate the traveling trajectory, based on the plurality of current reference values calculated by the reference value calculator.

### TECHNICAL FIELD

The present disclosure relates to a traveling trajectory generating apparatus that generates a traveling trajectory of a vehicle, in automated driving or semi-automated driving partially including manual driving.

### BACKGROUND ART

In automated driving of a subject vehicle, a trajectory along which the vehicle should follow is generated according to recognition information on states of the vehicle and a surrounding environment of the vehicle and according to a target state of the vehicle which has been determined based on the recognition information as disclosed in, for example, Patent Document 1. Accordingly, the vehicle is controlled along the generated trajectory.

Patent Document 1 discloses a vehicle traveling support apparatus involving traveling support control. Under this traveling support control, the vehicle traveling support apparatus determines a movable range of an object appearing from a dead angle so that a collision between the subject vehicle and the object is avoided based on the movable range.

### PRIOR ART DOCUMENT

### Patent Document

Patent Document 1: Japanese Patent Application Laid-Open No. 2006-260217

### Problem to be Solved by the Invention

Prevention of the collision between the subject vehicle and the object requires an abrupt direction change and deceleration of the subject vehicle. Thus, the target passage points and the target speeds calculated the last time greatly differ from those calculated this time. Consequently, Patent Document 1 has a problem of worsening the riding comfort, because a traveling trajectory along which behaviors of the vehicle are abruptly changed is generated.

The present disclosure has been conceived to solve the problem, and has an object of providing a traveling trajectory generating apparatus that allows a vehicle to continue automated driving with better riding comfort, even when a target state of the vehicle is greatly changed.

### MEANS TO SOLVE THE PROBLEM

The traveling trajectory generating apparatus according to the present disclosure that generates a traveling trajectory of a vehicle includes: a reference value storage to store, as a plurality of preceding reference values, a plurality of reference values including information on a state of the vehicle, the information being referred to when the traveling trajectory generating apparatus generates the traveling trajectory; a reference value calculator to calculate a plurality of current reference values, based on at least the plurality of preceding reference values and a target state that is a target value of a vehicle state quantity of the vehicle, the plurality of current reference values being referred to when the traveling trajectory generating apparatus generates the traveling trajectory in a current computation period; and a trajectory generator to generate the traveling trajectory, based on the plurality of current reference values calculated by the reference value calculator.

### Effects of the Invention

The traveling trajectory generating apparatus according to the present disclosure uses a plurality of current reference values calculated based on a target state and a plurality of preceding reference values, not referring to the target state as it is when generating a traveling trajectory. Thus, the impact on significant changes in the target state can be reduced, and the automated driving with better riding comfort can be continued.

### BRIEF DESCRIPTION OF DRAWINGS

FIG. 1 is a system configuration diagram illustrating a schematic structure of a vehicle on which a traveling trajectory generating apparatus according to Embodiment 1 is mounted.

FIG. 2 schematically illustrates a subject vehicle coordinate system to be used in Embodiment 1.

FIG. 3 is a functional block diagram of an automated driving system that generates a traveling trajectory by the traveling trajectory generating apparatus according to Embodiment 1.

FIG. 4 schematically illustrates lane information.

FIG. 5 is a flowchart illustrating a procedure for computing a reference value by a reference value calculator.

FIG. 6 schematically illustrates a method of extracting an initial reference value.

FIG. 7 schematically illustrates reference speeds.

FIG. 8 schematically illustrates reference lane transition rates.

FIG. 9 schematically illustrates reference passage points.

FIG. 10 schematically illustrates computation of a reference lateral deviation.

FIG. 11 schematically illustrates computation of a reference lateral deviation.

FIG. 12 schematically illustrates a change in the reference lateral deviation when a recognition position of an obstacle is abruptly changed.

FIG. 13 schematically illustrates a change in the reference lateral deviation when a recognition position of an obstacle is abruptly changed.

FIG. 14 is a functional block diagram of an automated driving system that generates a traveling trajectory by a traveling trajectory generating apparatus according to Embodiment 2.

FIG. 15 schematically illustrates an example traveling trajectory.

FIG. 16 schematically illustrates an example tree structure of planning points.

FIG. 17 is a flowchart illustrating a procedure for computing planning point reference values by a trajectory generator.

FIG. 18 illustrates a concept of a process of obtaining additional planning points.

FIG. 19 illustrates a concept of a process of selecting a selection planning point.

FIG. 20 illustrates a concept of processes of removing removal planning points from preceding planning points and adding additional planning points to the resulting planning points to produce current planning points.

FIG. 21 illustrates a concept of processes of extracting reference values corresponding to the planning points of the current planning points from the preceding planning point reference values and the additional planning point reference values and determining the extracted reference values to be current planning point reference values.

FIG. 22 is a flowchart illustrating a procedure for computing a reference value by the reference value calculator.

FIG. 23 illustrates a hardware configuration for implementing the traveling trajectory generating apparatuses according to Embodiments 1 and 2.

FIG. 24 illustrates a hardware configuration for implementing the traveling trajectory generating apparatuses according to Embodiments 1 and 2.

### DESCRIPTION OF EMBODIMENTS

### Embodiment 1

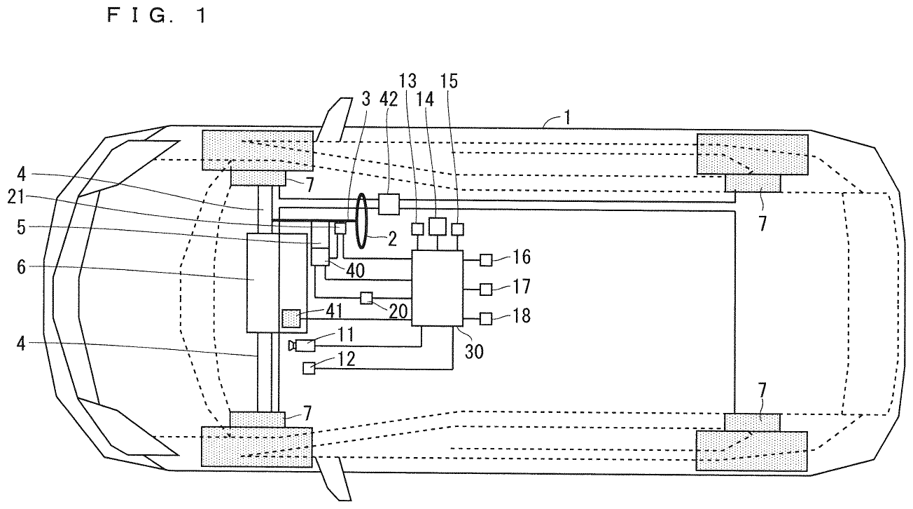

FIG. 1 is a system configuration diagram illustrating an example schematic structure of a vehicle 1 on which a traveling trajectory generating apparatus according to Embodiment 1 is mounted. As illustrated in FIG. 1, the vehicle 1 includes, as a drive system, a steering wheel 2, a steering axle 3, a steering unit 4, an electric power-steering (EPS) motor 5, a powertrain unit 6, and brake units 7.

Furthermore, the vehicle 1 includes, as a sensor system, a forward camera 11, a range sensor 12, a global navigation satellite system (GNSS) sensor 13, a yaw rate sensor 16, a speed sensor 17, an acceleration sensor 18, a steering angle sensor 20, and a steering torque sensor 21.

Besides these, the vehicle 1 includes a navigation device 14, a vehicle-to-everything (V2X) receiver 15, a vehicle control unit 30, an EPS controller 40, a powertrain controller 41, and a brake controller 42. The traveling trajectory generating apparatus according to Embodiment 1 is implemented as a part of the vehicle control unit 30.

The steering wheel 2 installed for driving the vehicle 1 by the driver is coupled to the steering axle 3. The steering axle 3 is coupled to the steering unit 4. The steering unit 4 rotatably supports two tires that are front wheels as steering wheels, and is supported by a car frame so that the steering unit 4 can be steered. Thus, a torque generated by the driver through operating the steering wheel 2 causes the steering axle 3 to rotate. The steering unit 4 horizontally steers the front wheels. Consequently, the driver can manipulate an amount of lateral movement of the vehicle 1 when the vehicle 1 moves forward or backward. The steering axle 3 may be rotated by the EPS motor 5. The EPS controller 40 controls the current that flows through the EPS motor 5, so that the front wheels can be steered independent of the operation of the steering wheel 2 by the driver.

The vehicle control unit 30 is an integrated circuit such as a microprocessor, and includes an analog/digital (A/D) conversion circuit, a digital/analog (D/A) conversion circuit, a central processing unit (CPU), a read-only memory (ROM), and a random-access memory (RAM).

The vehicle control unit 30 is connected to the forward camera 11, the range sensor 12, the GNSS sensor 13, the navigation device 14, the V2X receiver 15, the steering angle sensor 20 that senses a steering angle, the steering torque sensor 21 that senses a steering torque, the yaw rate sensor 16 that senses a yaw rate, the speed sensor 17 that senses a speed of the subject vehicle, the acceleration sensor 18 that senses an acceleration of the subject vehicle, the EPS controller 40, the powertrain controller 41, and the brake controller 42.

The vehicle control unit 30 processes information received from each of the connected sensors, according to a program stored in the ROM to transmit a target steering angle to the EPS controller 40, transmit a target driving force to the powertrain controller 41, and transmit a target braking force to the brake controller 42.

The forward camera 11 is disposed in a position where dividing lines ahead of the vehicle can be sensed as an image, and senses a forward environment of the subject vehicle such as lane information or a position of an obstacle, based on the image information. Although Embodiment 1 describes only the camera that senses the forward environment of the vehicle 1 as an example, the vehicle 1 may install cameras that sense 0 rear and lateral environments.

The range sensor 12 irradiates an obstacle around the subject vehicle with radio waves, light, or sound waves, and senses the reflected waves to output a relative distance to the obstacle and a relative speed of the obstacle. The range sensor 12 may be a range sensor based on a known system, such as a millimeter wave radar, a light detection and ranging (LiDAR), a laser range finder, or an ultrasonic radar.

The GNSS sensor 13 receives radio waves from a positioning satellite via an antenna, and performs positioning computation on the radio waves to output an absolute position and an absolute orientation of the vehicle 1.

The navigation device 14 has a function of computing the optimal traveling route to a destination set by the driver, and stores road information on the traveling route. The road information is map node data for representing road alignments. The map node data includes information on a latitude, a longitude, and an altitude which indicate an absolute position at each node, and information on a lane width, an angle of cant, and a tilt angle.

The V2X receiver 15 has functions of obtaining information through communication with other vehicles and roadside units and outputting the information. The obtained information includes information on a surrounding environment such as positions and speeds of the other vehicles and pedestrians and a no-entry zone in a road under construction.

The communication method of the V2X receiver 15 may be one of two standards, that is, dedicated short-range communications (DSRC) and Cellular-V2X (C-V2X), or a communication method other than these. The V2X receiver 15 is a receiver that can support communication methods adopted by communication targets such as the other vehicles and roadside units.

The EPS controller 40 controls the EPS motor 5 so that the EPS motor 5 attains the target steering angle transmitted from the vehicle control unit 30 to control a traveling trajectory of the vehicle 1.

The powertrain controller 41 controls the powertrain unit 6 so that the powertrain unit 6 attains the target driving force transmitted from the vehicle control unit 30.

Although Embodiment 1 describes an example vehicle including only an engine as a driving power source, Embodiment 1 is applicable to, for example, a vehicle including only an electric motor as a driving power source and a vehicle including both of an engine and an electric motor as driving power sources.

The brake controller 42 controls the brake units 7 so that the brake units 7 attain the target braking force transmitted from the vehicle control unit 30 to control deceleration of the vehicle 1.

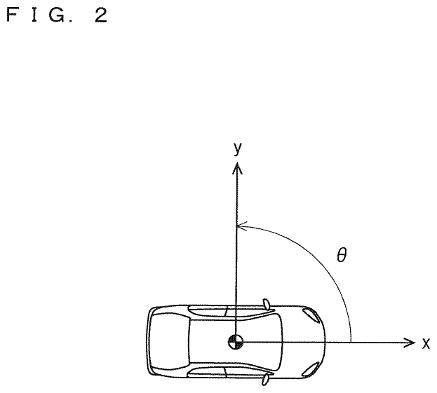

FIG. 2 schematically illustrates a subject vehicle coordinate system to be used in Embodiment 1. Specifically, x- and y-axes in FIG. 2 represent the subject vehicle coordinate system with respect to the center of gravity of the subject vehicle as the origin. The x-axis is taken ahead of the subject vehicle, and the y-axis is taken to the left of the subject vehicle. Furthermore, the angle θ is positive in the counterclockwise direction, with respect to the positive x-axis direction as a reference orientation.

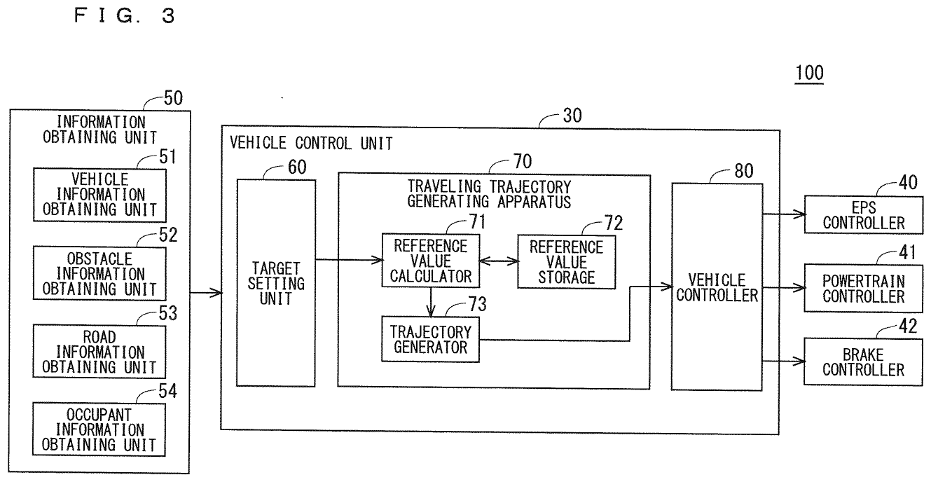

FIG. 3 is a functional block diagram of an automated driving system 100 that generates a traveling trajectory by a traveling trajectory generating apparatus 70 according to Embodiment 1. The automated driving system 100 includes the vehicle control unit 30 to which an information obtaining unit 50, the EPS controller 40, the powertrain controller 41, and the brake controller 42 are connected.

The information obtaining unit 50 has a function of obtaining information on the vehicle 1, information on a surrounding environment of the vehicle 1, and information on an occupant in the vehicle, and includes a vehicle information obtaining unit 510, an obstacle information obtaining unit 52, a road information obtaining unit 53, and an occupant information obtaining unit 54. The information obtaining unit 50 can also be referred to as an information obtaining device. The information obtained by the information obtaining unit 50 will be referred to as traveling information.

The vehicle information obtaining unit 510 obtains vehicle information that is the information on the vehicle 1. The vehicle information includes a state quantity representing a state of the vehicle 1, that is, a vehicle state quantity. The vehicle information obtaining unit 510 includes the GNSS sensor 13, the yaw rate sensor 16, the speed sensor 17, the acceleration sensor 18, the steering angle sensor 20, and the steering torque sensor 21.

The obstacle information obtaining unit 52 obtains obstacle information that is information on an obstacle around the vehicle 1. The obstacle information obtaining unit 52 includes the forward camera 11, the range sensor 12, and the V2X receiver 15.

The road information obtaining unit 53 obtains road information by performing a matching process on the subject vehicle position and map information stored by the navigation device 14. The road information obtaining unit 53 transforms N pieces of map data near the subject vehicle in a subject-vehicle traveling lane and a lane adjacent to the subject-vehicle traveling lane, into the subject vehicle coordinate system to output the resulting pieces of map data as lane information.

The occupant information obtaining unit 54 is a device that obtains a setting on automated driving which has been established by the occupant, and is mounted on the vehicle 1 as, for example, a tablet terminal or a touch panel. The occupant can establish the setting on automated driving, using such a device.

The road information obtaining unit 53 can store relative positions of a leading vehicle with respect to the subject vehicle which are obtained by the range sensor 12, transform N past relative positions into the current subject vehicle coordinate system, and output the resulting relative positions as the lane information. Here, a lane is a virtual line representing a center of the lane that is a center of white lines (dividing lines) on both sides of a vehicle on a road. A method of obtaining the lane information from the relative positions of the leading vehicle is as follows. For example, when the leading vehicle is located X0 m ahead and Y0 m to the left at a time t0 and the subject vehicle moves Xem forward and moves Yem to the left at a time t1, the position of the leading vehicle at the time t0 in the subject-vehicle coordinates at the time t1 is represented by (X0-Xem) ahead and (Y0-Yem) to the left. This is a method of transforming relative positions into the current subject vehicle coordinate system. If the relative position of the leading vehicle at the time t1 is further obtained as X1 m ahead and Y1 m to the left, a sequence of two points in the current subject vehicle coordinate system is obtained as the first point (X0-Xe, Y0-Ye) and the second point (X1, Y1) at this time.

Repeatedly storing and transforming positions in this manner can produce a trajectory of the leading vehicle in the current subject vehicle coordinate system. Assuming that the leading vehicle is traveling through the center of a lane, the lane information indicating the trajectory of the leading vehicle=the center of the lane is obtained.

The road information obtaining unit 53 can also output a lane shape obtained from the forward camera 11. The lane information according to Embodiment 1 includes a unique lane number defined for each lane as identification information. When sequences of points of the lanes have points with the same element number, the points are aligned perpendicular with respect to tangents to the lanes.

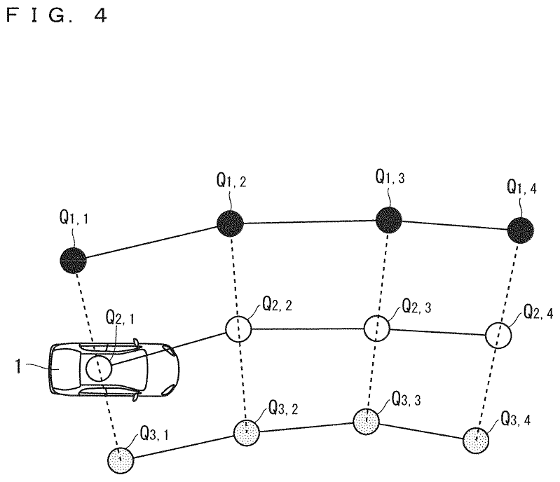

FIG. 4 schematically illustrates the lane information according to Embodiment 1, and illustrates three lanes represented by a plurality of sequences of points. In FIG. 4, the lane whose lane number is 2 is a subject-vehicle traveling lane of the vehicle 1. {Q_{1,i}} denotes each of the sequences of points, where 1 is a unique lane number defined for a lane and i is an element number. Assuming N as the number of the elements, each of the sequences of points can be expressed by Equation (1) below.

$$\begin{matrix}[ Math 1 ] & \\ \{ {Q}_{l , i} \} = \{ {Q}_{l , 1} , {Q}_{l , 2} , {Q}_{l , 3} , … , {Q}_{l , N} \} & ( 1 )\end{matrix}$$

Each of the points Q_{1,i} is represented by a position vector (qx_{1,i}, qy_{1,i}) in the subject-vehicle coordinates system and can be expressed by Equation (2) below.

$$\begin{matrix}[ Math 2 ] & \\ {Q}_{l , i} = ( {qx}_{l , i} , {qy}_{l , i} ) & ( 2 )\end{matrix}$$

For example, dummy lane information can be generated in a location whose road information is not stored in a navigation device or in a location without any dividing line, using a known method as disclosed in, for example, Japanese Patent Application Laid-Open No. 2020-75558. Furthermore, information obtained by the range sensor 12 and the forward camera 11 and indicating a region through which a vehicle can travel is available as the lane information.

The vehicle control unit 30 includes a target setting unit 60, the traveling trajectory generating apparatus 70, and a vehicle controller 80.

The target setting unit 60 has a function of calculating a target state that is a target value of a vehicle state quantity, based on the traveling information obtained from the information obtaining unit 50, and a function of outputting the calculated target state to the traveling trajectory generating apparatus 70. Examples of the vehicle state quantity included in the target state include a position, an orientation, a speed, an acceleration, a rotation speed, a steering angle, and a steering angular velocity, a lateral deviation with respect to the center of a following lane, and a following lane number of a car body, and any combinations of these. In Embodiment 1, the following lane number and the speed are used as the vehicle state quantities. Although the target state is represented by a scalar value based on each of the state quantities in Embodiment 1, the target state can be represented by a data sequence, a parametric representation, or a combination of these. A following lane number in the target state will be referred to as a target following lane number, and a speed in the target state will be referred to as a target speed.

The traveling trajectory generating apparatus 70 has a function of calculating a traveling trajectory allowing the vehicle 1 to follow a leading vehicle, and a function of outputting information on the calculated traveling trajectory to the vehicle controller 80.

The vehicle controller 80 has functions of computing the target steering angle to be transferred to the EPS controller 40, the target driving force to be transferred to the powertrain controller 41, and the target braking force to be transferred to the brake controller 42, using information on the traveling trajectory obtained from the traveling trajectory generating apparatus 70 and the vehicle state quantity obtained from the information obtaining unit 50, and outputting the target steering angle, the target driving force, and the target braking force. The vehicle controller 80 can also be referred to as a vehicle control device.

The traveling trajectory generating apparatus 70 includes a reference value calculator 71, a reference value storage 72, and a trajectory generator 73. The reference value calculator 71, the reference value storage 72, and the trajectory generator 73 will be described hereinafter.

The reference value calculator 71 has functions of newly calculating current reference values, based on the traveling information obtained from the information obtaining unit 50, the target state obtained from the target setting unit 60, and preceding reference values obtained from the reference value storage 72, and outputting the current reference values to the reference value storage 72 and the trajectory generator 73. The traveling trajectory generating apparatus according to the present disclosure is an apparatus that periodically repeats the computation for generating a traveling trajectory. A present computation period will be referred to as a “current computation period”, and an immediately preceding computation period from the present time will be referred to as a “preceding computation period”. Similarly, distinctions are made between reference values by adding “current” or “preceding” to the reference values.

Here, the reference values are information on states of the vehicle 1 to be referred to when a traveling trajectory is generated. The reference values according to Embodiment 1 include information on a following lane number and a lane transition rate to be used for calculating a reference position, besides passage points and speeds to be referred to when the trajectory is generated. These pieces of information on the reference values are represented by a reference passage point {Pᵢ}, a reference speed {vᵢ}, a reference following lane number L, and a reference lane transition rate {λᵢ}. Here, the reference lane transition rate {λᵢ} represents a degree of transition from the current following lane to a target following lane in an element i. The details will be described later.

A set of passage points, a set of speeds, and a set of lane transition rates are each represented by a data sequence whose data length is M. The reference passage point {Pᵢ}, the reference speed {vᵢ}, and the reference lane transition rate {λᵢ} are expressed by Equation (3), Equation (4), and Equation (5) below, respectively.

$$\begin{matrix}[ Math 3 ] & \\ \{ {P}_{i} \} = \{ {P}_{1} , {P}_{2} , {P}_{3} , … , {P}_{M} \} & ( 3 )\end{matrix}$$

$$\begin{matrix}[ Math 4 ] & \\ \{ {V}_{i} \} = \{ {V}_{1} , {V}_{2} , {V}_{3} , … , {V}_{M} \} & ( 4 )\end{matrix}$$

$$\begin{matrix}[ Math 5 ] & \\ \{ {λ}_{i} \} = \{ {λ}_{1} , {λ}_{2} , {λ}_{3} , … , {λ}_{M} \} & ( 5 )\end{matrix}$$

Each data of the passage points is represented by a position vector (pxᵢ, pyᵢ) in the subject-vehicle coordinates system and expressed by Equation (6) below.

$$\begin{matrix}[ Math 6 ] & \\ {P}_{i} = ( {px}_{i} , {py}_{i} ) & ( 6 )\end{matrix}$$

The reference values are not limited to these but can include information on, for example, an arrival point, an orientation, a speed, an acceleration, a rotation speed, a steering angle, a steering angular velocity, and a lateral deviation with respect to a passage point.

A set of passage points, a set of speeds, and a set of lane transition rates are each represented by a data sequence, whereas a set of reference following lane numbers is represented by scalar values in Embodiment 1. Besides, the set of passage points, the set of speeds, the set of lane transition rates, and the set of reference following lane numbers can be each represented by scalar values and a data sequence. When the set of passage points, the set of speeds, the set of lane transition rates are each represented by scalar values, the data length is 1. Furthermore, the parametric representation is available.

The reference value storage 72 has functions of storing the reference values output from the reference value calculator 71, and outputting the stored reference values to the reference value calculator 71 as preceding reference values in the next computation period.

The trajectory generator 73 has a function of generating a traveling trajectory along which the vehicle should follow, based on the traveling information and the reference values obtained from the reference value calculator 71. Here, a method of generating the traveling trajectory from passage points and speeds is known. For example, WO2020/129208 discloses generating a traveling trajectory by performing state estimation computation on a vehicle state quantity using a vehicle model. WO2020/129208 discloses application of Bayesian filters as an example of the state estimation computation. The traveling trajectory to be generated is represented by a sequence of points including a vehicle state quantity.

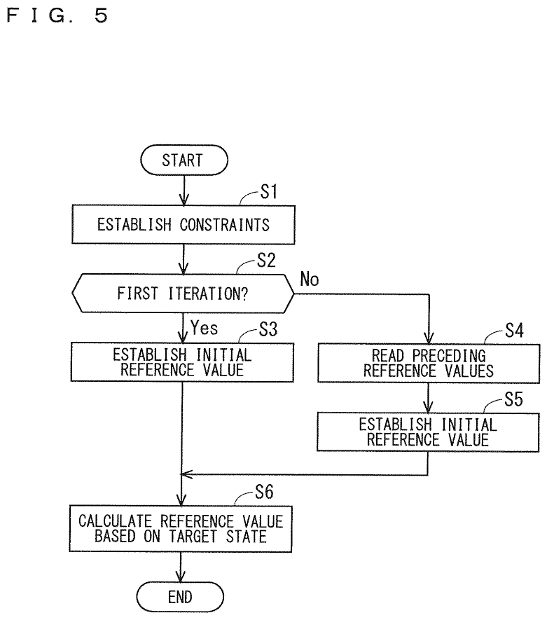

FIG. 5 is a flowchart illustrating a procedure for computing a reference value by the reference value calculator 71. Upon starting operations, the reference value calculator 71 first establishes constraints to be used for adjusting particular reference values (Step S1). The reference value calculator 71 according to Embodiment 1 establishes an upper-limit acceleration absolute value aₗᵢₘ and a lane change time t_{1c} that are preset as constraints. Here, the reference values correspond to, for example, a target passage point and a target speed. Examples of the constraints include a condition that “an acceleration must be lower than or equal to the upper-limit acceleration absolute value aₗᵢₘ”. The constraints are essential conditions for following target values. Thus, in the presence of target passage points at which the constraints cannot be adhered to, the vehicle is to follow the target passage points with the constraints being prioritized. Not all the reference values are subject to the constraints. For example, no constraint is established for calculating passage points or reference following lane numbers.

Establishing the constraints can prevent vehicle behaviors beyond the constraints, and enables automated driving in consideration of the riding comfort and the safety.

The constraints can be changed according to the traveling information and a target state. Examples of changing the constraints include obtaining information on an operation of an occupant on the occupant information obtaining unit 54 and then changing the constraints according to the operation. Here, the operation of the occupant on the occupant information obtaining unit 54 is, for example, an operation performed by the occupant on a tablet terminal when the occupant information obtaining unit 54 is the tablet terminal. The occupant can establish the setting on automated driving using this tablet terminal, for example, “changing a lane” or “increasing a vehicle speed”.

The vehicle state quantities as the constraints are not limited to an acceleration and a lane change time, but can include a speed, a jerk, a steering angle, a steering angular velocity, a steering angle acceleration, a rotation speed, a rotation acceleration, a vehicle sideslip angle, a tire sideslip angle, and any combinations of these.

After the constraints are established in Step S1, the processes proceed to Step S2 where it is determined whether the number of iterations of the computation for generating a trajectory by the traveling trajectory generating apparatus 70 is the first iteration since the start of the traveling trajectory generating apparatus 70. When the number of iterations is the first iteration (Yes), the processes proceed to Step S3. Otherwise (No), the processes proceed to Step S4.

In Step S3, an initial value of each reference value is established based on the target state or the traveling information. The initial value of reference speeds is the current speed of the vehicle 1. The initial value of reference following lane numbers is a traveling lane number of the vehicle 1. The initial value of reference lane transition rates is 0. The initial value of passage points is not defined herein. The initial value of reference speeds can be a target speed. The initial value of reference following lane numbers can be a target following lane number.

In Step S4, the reference values stored in the reference value storage 72 are read as preceding reference values. Then, the processes proceed to Step S5.

In Step S5, an initial reference value is established based on the preceding reference values. A preceding reference value of a reference value represented by a scalar value is determined as an initial value. Data corresponding to the current time is extracted from reference values represented by a data sequence, and is determined as an initial reference value. There is no limitation on a method of extracting the data corresponding to the current time. Examples of the method include determining a distance between each passage point and a vehicle position obtained in a preceding computation from the passage point information corresponding to the preceding reference values, estimating a moving distance of the vehicle 1 based on the current speed and an elapsed time from the preceding computation, extracting one of the determined distances between the passage points and the vehicle positions obtained in the preceding computation that is the closest to the estimated moving distance of the vehicle 1, and defining the determined distance as an initial reference value.

Here, reference values on rear positions when viewed from the vehicle position in the preceding computation are eliminated from targets to be selected. The data lengths of the reference values represented by a data sequence are all the same.

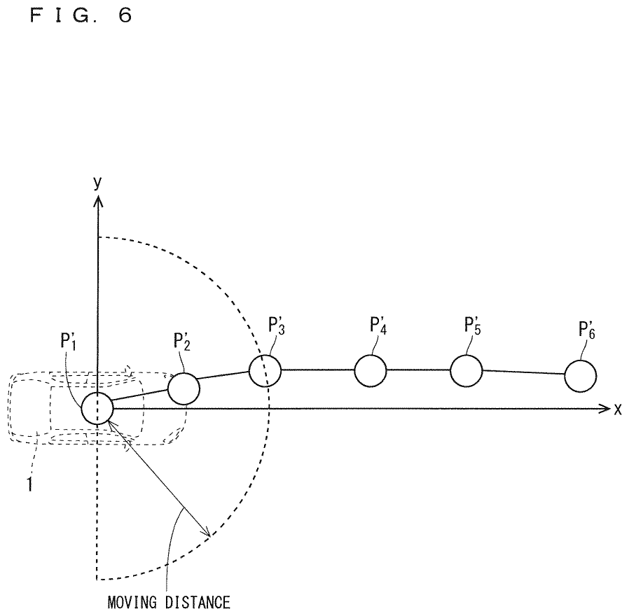

FIG. 6 schematically illustrates the method of extracting an initial reference value. {P′ᵢ} denotes passage points corresponding to preceding reference values. FIG. 6 illustrates that the preceding reference values include information on passage points P′₁, P′₂, P′₃, P′₄, P′₅, and P′₆. FIG. 6 illustrates the position of the vehicle 1 in the preceding computation using broken lines. FIG. 6 also illustrates the moving distance of the vehicle 1 estimated based on the current speed and the elapsed time from the preceding computation, using a semicircle having its center at the position of the vehicle 1 in the preceding computation, that is, the passage point P′ᵢ. FIG. 6 shows that the passage point P′₃ is the closest to the estimated moving distance. Thus, the third element of the reference values represented by a data sequence is determined to be the initial reference value.

Although extracting data at the current time from the passage point information is described above, time information can be assigned to each of the reference values so that data the closest to the current time can be extracted. Here, the data lengths of the reference values need not be all the same. Although data corresponding to one of the preceding reference values is extracted in the description above, a value interpolated based on distance information or time information can be an initial reference value.

After the initial reference value is established in Step S3 or Step S5, the processes proceed to Step S6. In Step S6, a new reference value is calculated based on the constraints established in Step S2, the initial reference value established in Step S3 or Step S5, and the target state obtained from the target setting unit 60. The following will describe a method of calculating the reference value.

First, how to calculate a reference speed will be described. Assuming that vₜ denotes a target speed, Lₜ denotes a target following lane number, and sᵢ denotes a distance from the first point to each point in a sequence of points {Q_{Lt,i}} representing a target following lane, the distance sᵢ is expressed by Equation (7) below, where s₁ is 0.

$$\begin{matrix}[ Math 7 ] & \\ {s}_{i} = {\sum }_{j = 1}^{i - 1} \text{?} & ( 7 )\end{matrix}$$

$$\text{?} \text{indicates text missing or illegible when filed}$$

A reference value {vᵢ} is determined from Equation (8) below, using an initial value v₀ of reference speeds and the upper-limit acceleration absolute value aₗᵢₘ.

$$\begin{matrix}[ Math 8 ] & \\ {v}_{i} = \sqrt{{v}_{0}^{2} + sgn ( {v}_{t}^{2} - {v}_{0}^{2} ) \cdot min ( \vert {v}_{t}^{2} - {v}_{0}^{2} \vert , 2 {a}_{lim} {s}_{i} )} & ( 8 )\end{matrix}$$

Here, sgn is a function generally referred to as a sign function, and is expressed by Equation (9) below.

$$\begin{matrix}[ Math 9 ] & \\ sgn ( x ) = \{ \begin{matrix}1 : x > 0 \\ 0 : x = 0 \\ - 1 : x < 0\end{matrix} & ( 9 )\end{matrix}$$

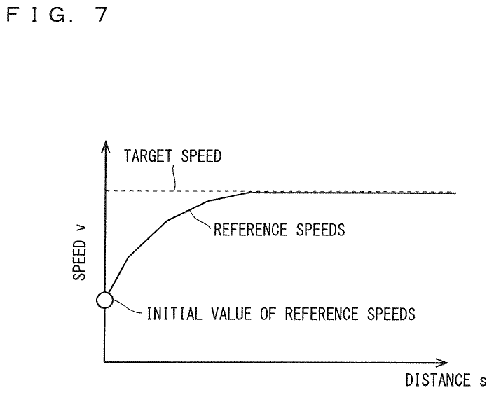

FIG. 7 schematically illustrates the reference speeds determined in the aforementioned method. In FIG. 7, the horizontal axis represents the distance s, and the vertical axis represents the speed v. FIG. 7 illustrates the reference speeds reaching the target speed using a slight curve, with respect to the initial value of the reference speeds as the origin.

Next, how to calculate a reference following lane number, a reference lane transition rate, and a reference passage point will be described. When the target following lane number Lₜ is equal to an initial value L₀ of the reference following lane numbers or when an initial value λ₀ of the lane transition rates is larger than or equal to 1, the reference following lane number L, the reference lane transition rate {λᵢ}, and the reference passage point {Pᵢ} are expressed by Equation (10), Equation (11), and Equation (12) below, respectively.

$$\begin{matrix}[ Math 10 ] & \\ L = {L}_{t} & ( 10 )\end{matrix}$$

$$\begin{matrix}[ Math 11 ] & \\ {λ}_{i} = 0 & ( 11 )\end{matrix}$$

$$\begin{matrix}[ Math 12 ] & \\ {P}_{i} = {Q}_{{L}_{t} i} & ( 12 )\end{matrix}$$

When the target following lane number Lₜ is different from the initial value L₀ of the reference following lane numbers and when the initial value λ₀ of the reference lane transition rates is smaller than 1, a reference value is determined in the following method. First, the reference following lane number L is set equal to the initial value L₀ as indicated by Equation (13) below.

$$\begin{matrix}[ Math 13 ] & \\ L = {L}_{0} & ( 13 )\end{matrix}$$

Next, a predicted elapsed time tᵢ to each point in the sequence of points {Q_{Lt,i}} representing the target following lane is defined by Equation (14) below.

$$\begin{matrix}[ Math 14 ] & \\ {t}_{i} = \text{?} \frac{{s}_{j}}{{v}_{j}} & ( 14 )\end{matrix}$$

$$\text{?} \text{indicates text missing or illegible when filed}$$

The reference lane transition rate {A} is calculated from the predicted elapsed time tᵢ and the lane change time t_{1c} using Equation (15) below.

$$\begin{matrix}[ Math 15 ] & \\ {λ}_{i} = min ( {λ}_{0} + \frac{{t}_{i}}{\text{?}} , 1 ) & ( 15 )\end{matrix}$$

$$\text{?} \text{indicates text missing or illegible when filed}$$

As indicated by Equation (15), the reference lane transition rate is a value obtained by dividing the predicted elapsed time by the lane change time. Since a trajectory is generated so that a lane change is completed within the lane change time t_{1c}, dividing the predicted elapsed time by the lane change time represents to which degree the lane change has been proceeded in an i-th point.

Here, the lane change time is a preset time. The lane change time, for example, is set to a time during which the occupant does not feel stresses in changing a lane, and can be set by the occupant through the occupant information obtaining unit 54 to suit preferences of the occupant. Furthermore, the lane change time can be included in a target state.

Next, a reference passage point {Pᵢ} is calculated from the sequence of points {Q_{L, i}} representing the reference following lane, the sequence of points {Q_{Lt,i}} representing the target following lane, and the reference lane transition rate {λᵢ} using Equation (16) below.

$$\begin{matrix}[ Math 16 ] & \\ {P}_{i} = \frac{1 + cos ( \text{?} π )}{2} {Q}_{L , i} + \frac{1 - cos ( {λ}_{i} π )}{2} \text{?} & ( 16 )\end{matrix}$$

$$\text{?} \text{indicates text missing or illegible when filed}$$

Although a passage point is determined by applying a trigonometric function to the lane transition rate in Embodiment 1 as indicated by Equation (16), the passage point can be determined by applying a sigmoid function or directly multiplying a sequence of points of a lane by a lane transition rate.

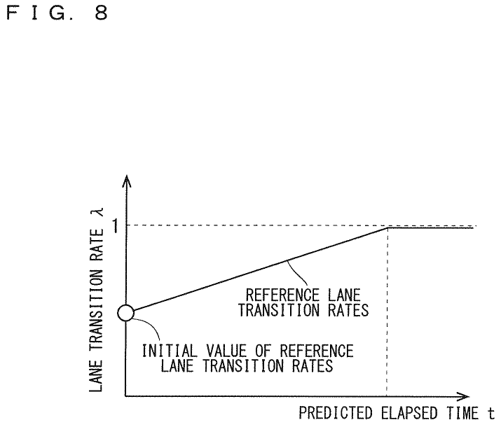

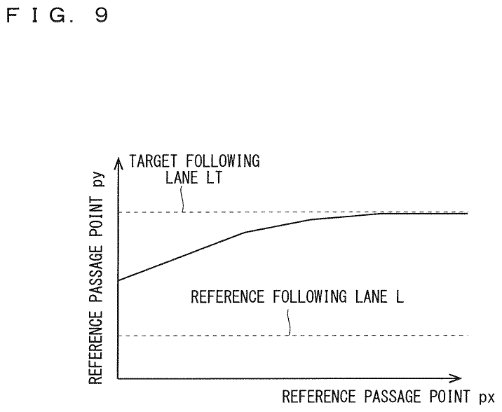

FIG. 8 and FIG. 9 schematically illustrate the reference lane transition rates and the reference passage points, respectively, which have been determined in the aforementioned methods. In FIG. 8, the horizontal axis represents the predicted elapsed time t, and the vertical axis represents the reference lane transition rate λᵢ. In FIG. 8, the reference lane transition rate is increased in proportion to the predicted elapsed time with respect to the initial value of the reference lane transition rates as the origin, to 100%, that is, 1. In FIG. 9, the horizontal axis represents the reference passage point px in the x-axis direction, and the vertical axis represents the reference passage point py in the y-axis direction. FIG. 9 illustrates a trajectory reaching the target following lane LT using a slight curve.

As described above, the traveling trajectory generating apparatus 70 generates a traveling trajectory based on the current reference value adjusted using a target state of the vehicle 1 and preceding reference values, that is, target values. Thus, the vehicle 1 can realize the target state, that is, the automated driving with better riding comfort, with abrupt changes in the following lane and the speed being reduced herein.

### Modification 1

Embodiment 1 describes that the constraints can be changed according to the traveling information and target states. Here, the target states obtained from the target setting unit 60 include emergency, and the constraints to be used by the reference value calculator 71 can be changed according to a value of the emergency. For example, the higher the emergency is, the more the range of the vehicle state quantity allowed under the constraints can be widened. When the emergency is higher than a predetermined threshold, the constraints can be equal to the limitations of dynamic performance of the vehicle.

Here, the emergency is associated with responsiveness required for each of the state quantities other than the emergency which are included in the target states. For example, when the state quantities other than the emergency which are included in the target states are a position, an orientation, a speed, an acceleration, a rotation speed, a steering angle, and a steering angular velocity, and a lateral deviation with respect to the center of a following lane of the car body, the responsiveness can be defined by the time taken for each of the state quantities to converge to a target value within a certain tolerance. A state quantity with high responsiveness impacts the riding comfort. Furthermore, the responsiveness of a following lane number can be defined as the responsiveness of a lane transition rate. If this responsiveness is high, the riding comfort is impacted due to, for example, an abrupt lane change.

Thus, changing the constraints according to the emergency of a traveling state and assigning a higher priority to the responsiveness than to the riding comfort when the emergency is high enable the automated driving with higher safety.

### Modification 2

In the presence of an obstacle in the vicinity of reference passage points, a traveling trajectory horizontally displaced with respect to the reference passage points may be desired. Here, reference values include a reference lateral deviation representing a lateral deviation that the vehicle should take with respect to the reference passage points. Thus, the reference value calculator 71 can be configured to have a function of determining the reference lateral deviation according to a position of the obstacle. Furthermore, the constraints include a change speed upper limit value uₗᵢₘ for the lateral deviation. The reference lateral deviation is represented by a data sequence {dᵢ}. The following will describe an example of how to determine the reference lateral deviation.

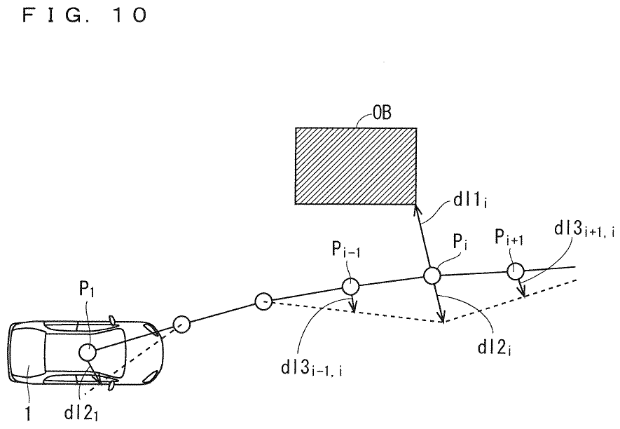

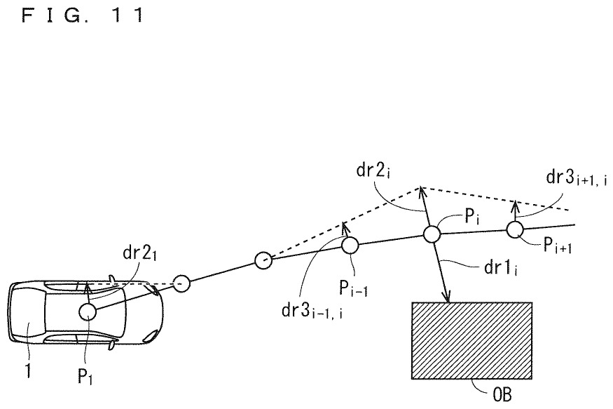

FIGS. 10 and 11 schematically illustrate computation of the reference lateral deviation. FIG. 10 illustrates processes in the presence of an obstacle OB to the left with respect to the orientation of the vehicle 1 at the reference passage point Pᵢ. FIG. 11 illustrates processes in the presence of the obstacle OB to the right with respect to the orientation of the vehicle 1 at the reference passage point Pᵢ.

A distance from each of the reference passage points to a point of intersection of a straight line extending perpendicular to a tangent at the reference passage point and a boundary of an occupied region of the obstacle OB in FIGS. 10 and 11 is calculated. Here, the tangent at the reference passage point is defined as follows: for example, assuming that θᵢ denotes an average of a slope of a straight line connecting a reference passage point Pᵢ₋₁ to a reference passage point Pᵢ and a slope of a straight line connecting the reference passage point Pᵢ to a reference passage point Pᵢ₊₁, a straight line having the slope θᵢ and passing through the reference passage point Pᵢ is defined as a tangent at the reference passage point Pᵢ. When the reference passage points are connected in an interpolation method such as spline interpolation, the reference passage points are continuously connected by curves in the spline interpolation. Thus, the straight line having the slope θᵢ and passing through the reference passage point Pᵢ can be defined as a curved tangent at the reference passage point Pᵢ.

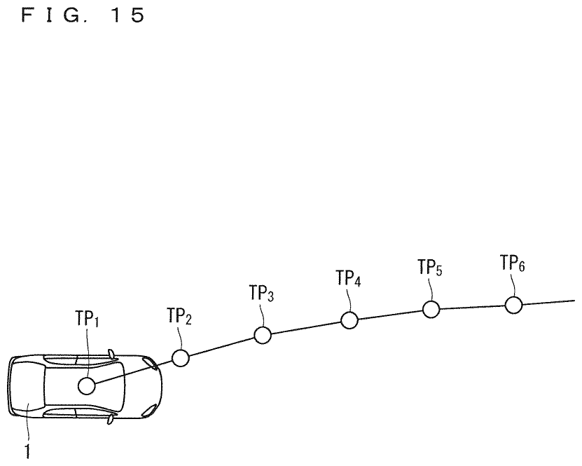

{dl1ᵢ} denotes a distance of the straight line extending from each of the reference passage points to the left, and {dr1ᵢ} denotes a distance of the straight line extending from the reference passage point to the right, with respect to the orientation of the vehicle 1. In the absence of the point of intersection with the boundary of the occupied region of the obstacle OB, a sufficient large value is substituted for the distance. Wᵥ denotes a width of the car body of the vehicle 1. A safety margin M_{obs} between the obstacle OB and the vehicle 1 is preset. A distance illustrated by an arrow extending opposite to an arrow illustrating the distance {dl1ᵢ} is defined as the smallest lateral deviation {dl2ᵢ} in FIG. 10. A distance illustrated by an arrow extending opposite to an arrow illustrating the distance {dr1ᵢ} is defined as the smallest lateral deviation {dr2ᵢ} in FIG. 15. The smallest lateral deviation {dl2ᵢ} and the smallest lateral deviation {dr2ᵢ} can be determined by Equation (17) and Equation (18), respectively.

$$\begin{matrix}[ Math 17 ] & \\ dl {2}_{i} = - min ( dl {1}_{i} - \frac{{W}_{v}}{2} - {M}_{obs} , 0 ) & ( 17 )\end{matrix}$$

$$\begin{matrix}[ Math 18 ] & \\ dr {2}_{i} = - min ( dr {1}_{i} - \frac{{W}_{v}}{2} - {M}_{obs} , 0 ) & ( 18 )\end{matrix}$$

Here, a distance illustrated by an arrow at the reference passage point Pᵢ₋₁ is defined as a lateral deviation {dl3_{i-1,i}} and a distance illustrated by an arrow at the reference passage point Pᵢ₊₁ is defined as a lateral deviation {dl3_{i+1,i}}, with respect to the smallest lateral deviation {dl2ᵢ} at the reference passage point Pᵢ in FIG. 10. These lateral deviations are lateral deviations set at the reference passage points before and after the reference passage point Pᵢ to set the realistic smallest lateral deviation {d12ᵢ} under the constraint of the change speed upper limit value uₗᵢₘ for the lateral deviation. Setting these can reduce the speed for the lateral deviation of the vehicle 1, and prevent a decrease in the riding comfort.

Similarly, a distance illustrated by an arrow at the reference passage point Pᵢ₋₁ is defined as a lateral deviation {dr3_{i-1,i}} and a distance illustrated by an arrow at the reference passage point Pᵢ₊₁ is defined as a lateral deviation {dr3_{i+1,i}}, with respect to the smallest lateral deviation {dr2ᵢ} at the reference passage point Pᵢ in FIG. 11.

The smallest lateral deviation {dl2ᵢ} at the reference passage point Pᵢ that is an initial position in FIG. 10 and the smallest lateral deviation {dr2ᵢ} at the reference passage point Pᵢ that is an initial position in FIG. 11 are determined by Equation (19) and Equation (20), respectively, using a lateral deviation do that is included in reference values at the initial positions.

$$\begin{matrix}[ Math 19 ] & \\ dl {2}_{1} = max ( - {d}_{0} , 0 ) & ( 19 )\end{matrix}$$

$$\begin{matrix}[ Math 20 ] & \\ dr {2}_{1} = max ( - {d}_{0} , 0 ) & ( 20 )\end{matrix}$$

When the change speed for the lateral deviation is limited to uₗᵢₘ or less, lateral deviations {dl3_{i,j}} and {dr3_{i,j}} that should be secured in the element i to realize the smallest lateral deviation in an element j are determined by Equation (21) and Equation (22), respectively, using the predicted elapsed time tᵢ.

$$\begin{matrix}[ Math 21 ] & \\ \{ dl {3}_{i , j} \} = \{ dl {3}_{i , 1} , dl {3}_{i , 2} , dl {3}_{i , 3} … dl {3}_{i , M} \} & ( 21 )\end{matrix}$$

$$\begin{matrix}[ Math 22 ] & \\ \{ dr {3}_{i , j} \} = \{ dr {3}_{i , 1} , dr {3}_{i , 2} , dr {3}_{i , 3} … dr {3}_{i , M} \} & ( 22 )\end{matrix}$$

The lateral deviations dl3ᵢⱼ and dr3ᵢⱼ at the respective reference passage points in Equation (21) and Equation (22) are determined by Equation (23) and Equation (24) below, respectively.

$$\begin{matrix}[ Math 23 ] & \\ dl {3}_{i , j} = max ( dl {2}_{j} - \vert {t}_{i} - {t}_{j} \vert \cdot {u}_{lim} , 0 ) & ( 23 )\end{matrix}$$

$$\begin{matrix}[ Math 24 ] & \\ dr {3}_{i , j} = max ( dr {2}_{j} - \vert {t}_{i} - {t}_{j} \vert \cdot {u}_{lim} , 0 ) & ( 24 )\end{matrix}$$

Here, the element j corresponds to the reference passage point Pᵢ for calculating each of the smallest lateral deviation {dl2ᵢ} and the smallest lateral deviation {dr2ᵢ} as described above. The element i corresponds to each of the reference passage point Pᵢ₋₁ and the b reference passage point Pᵢ₊₁ that are the reference passage points before and after the reference passage point Pᵢ.

For example, when the change speed for the lateral deviation is limited to Him or less where i=j−1, a difference between the lateral deviation in the element j and the lateral deviation in an element j−1 needs to be smaller than or equal to a certain value Δdl2ⱼ. In other words, realization of the smallest lateral deviation dl2ⱼ in the element j requires the lateral deviation in the element j−1 to be larger than at least dl2ⱼ−Δdl2ⱼ. This is what the lateral deviation to be secured in the element i means. The certain value Δdl2ⱼ corresponds to |ti−tj|·uₗᵢₘ in Equation (23) and Equation (24). Since i=j−1, the certain value Δdl2ⱼ can be expressed by Equation (25).

$$\begin{matrix}[ Math 25 ] & \\ Δ dl {2}_{j} = \vert {t}_{j} - \text{?} \vert \cdot {u}_{lim} & ( 25 )\end{matrix}$$

$$\text{?} \text{indicates text missing or illegible when filed}$$

A left lateral deviation dlᵢ and a right lateral deviation drᵢ in the respective elements i represent the maximum values of the lateral deviation {dl3_{i,j}} and the lateral deviation {dr3_{i,j}}, and are determined by Equation (26) and Equation (27), respectively.

$$\begin{matrix}[ Math 26 ] & \\ {dl}_{i} = max \{ dl {3}_{i , j} \} & ( 26 )\end{matrix}$$

$$\begin{matrix}[ Math 27 ] & \\ {dr}_{i} = max \{ dr {3}_{i , j} \} & ( 27 )\end{matrix}$$

Then, a reference lateral deviation dᵢ is determined from the left lateral deviation dlᵢ and the right lateral deviation drᵢ by Equation (28) below.

$$\begin{matrix}[ Math 28 ] & \\ {d}_{i} = {dr}_{i} - {dl}_{i} & ( 28 )\end{matrix}$$

As described above, a lateral deviation can be changed under the constraints, using a lateral deviation when a preceding trajectory has been generated as an initial value. Since the recognition accuracy of the obstacle OB is low, abrupt changes in the vehicle behaviors can be suppressed even when the position of the obstacle to be recognized is abruptly changed.

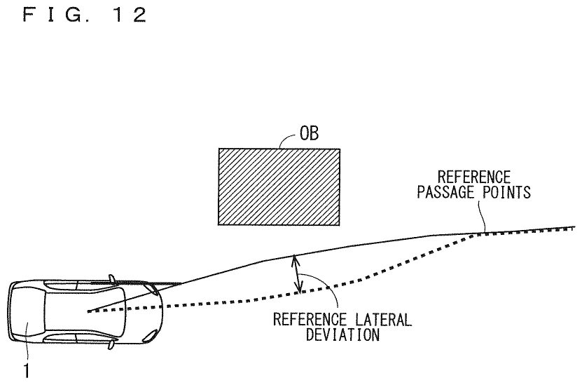

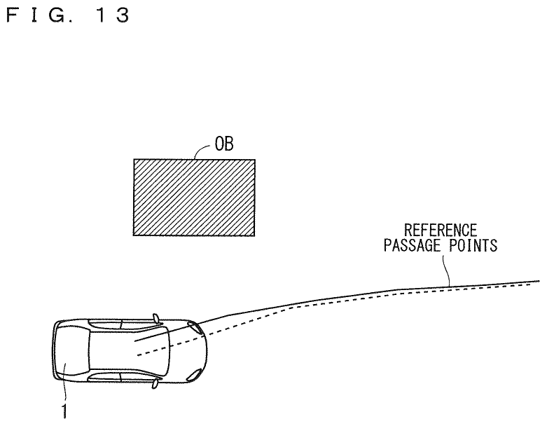

FIGS. 12 and 13 schematically illustrate changes in the reference lateral deviation when the recognition position of the obstacle OB is abruptly changed. In each of FIGS. 12 and 13, a solid line represents reference passage points, and a broken line represents a traveling trajectory obtained in consideration of the reference passage points and the reference lateral deviation. Since the obstacle OB is close to the reference passage points at the time of FIG. 12, a traveling trajectory that avoids the obstacle is generated with a large reference lateral deviation. At the time of FIG. 13 through the time of FIG. 12, the recognition position of the obstacle OB is greatly changed from that at the time of FIG. 12, and the obstacle OB is distant from the reference passage points. Thus, there is no need to avoid the obstacle OB. Here, a reference lateral deviation that approximates gradually to 0 is calculated, using a reference lateral deviation when the preceding trajectory has been generated as the initial value. This can suppress abrupt changes in a trajectory even when the recognition position of the obstacle OB is abruptly changed, and improve the riding comfort.

### Embodiment 2

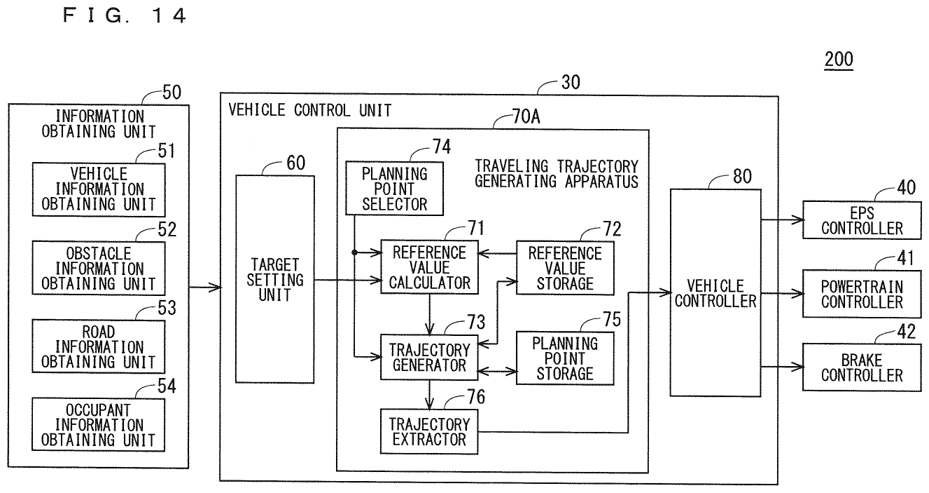

FIG. 14 is a functional block diagram of an automated driving system 200 that generates a traveling trajectory by a traveling trajectory generating apparatus according to Embodiment 2. The same reference numerals are applied to the same structures as those of the automated driving system 100 described with reference to FIG. 3, and the overlapping description is omitted. The system configuration of the vehicle 1 on which the automated driving system 200 is mounted is identical to that in FIG. 1.

The vehicle control unit 30 includes the target setting unit 60, a traveling trajectory generating apparatus 70A, and the vehicle controller 80. The traveling trajectory generating apparatus 70A has a structure obtained by adding a planning point selector 74, a planning point storage 75, and a trajectory extractor 76 to the traveling trajectory generating apparatus 70 according to Embodiment 1, and features the use of planning points in calculating reference values.

Although the planning points are almost identical to points forming a traveling trajectory, the planning points differ from the points forming the traveling trajectory in how to establish connections between the points. Specifically, only one point is connected each before and after a point of a traveling trajectory at a certain time, whereas any number of planning points can be connected after a planning point at a certain time to adopt a tree structure although only one planning point is connected before the planning point at the certain time.

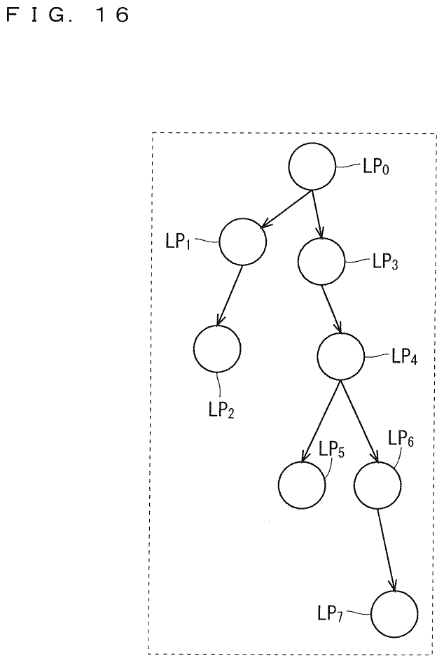

FIG. 15 schematically illustrates an example traveling trajectory, and FIG. 16 schematically illustrates an example tree structure of planning points.

As illustrated in FIG. 15, a traveling trajectory is represented by a sequence of points TP₁ to TP₆. Points connected to a point at a certain time are points before and after the point at the certain time, except the starting point and the end point. As illustrated in FIG. 16, the planning points are represented by a sequence of points LP₁ to LP₇. Although one planning point is connected before a planning point at a certain time except the starting point and the end point, a plurality of planning points are connected after the planning point at the certain time. The planning points sometimes branch off.

Here, FIG. 14 is again described. The planning point selector 74 has functions of selecting one planning point as one selection planning point from among preceding planning points stored in the planning point storage 75, and outputting a selection planning point number that is an identification number of the selection planning point to the reference value calculator 71 and the trajectory generator 73.

Methods of selecting a planning point are not particularly limited. Examples of the methods include a method of determining a planning point selected using randomized values, and a method of determining a planning point selected based on a target state or the traveling information. The planning point selector 74 outputs an invalid value as the selection planning point number at the first computation for generating a trajectory without performing a process of selecting a planning point, which will be described later.

The reference value calculator 71 has functions of newly calculating reference values, based on the traveling information, the target state, preceding planning point reference values stored in the reference value storage 72, and the selection planning point number obtained from the planning point selector 74, and outputting the reference values to the trajectory generator 73. Here, the preceding planning point reference values are planning point reference values corresponding to the planning points obtained in the preceding computation period. The planning point reference values are not always identical to reference values, but include planning point reference values corresponding to all the planning points.

The trajectory generator 73 has functions of generating a plurality of planning points based on the traveling information, the reference values, the selection planning point number, and the preceding planning points and outputting the plurality of planning points to the planning point storage 75 and the trajectory extractor 76, and also calculating planning point reference values corresponding to the planning points and outputting the planning point reference values to the reference value storage 72.

As previously described, information on the connections between the points is assigned to each of the planning points. Methods of representing the connection information are not particularly limited. For example, assuming that a planning point before a planning point at a certain time or a planning point with a short moving distance from the subject vehicle position is a “parent” and a planning point after the planning point at the certain time or a planning point with a long moving distance from the subject vehicle position is a “child”, the connection information can be represented by identification numbers of planning points determined to be the parent and the child of each planning point.

The reference value storage 72 has functions of storing the planning point reference values output from the trajectory generator 73, and outputting the stored planning point reference values to the reference value calculator 71 as the preceding planning point reference values in the next computation period.

The planning point storage 75 has functions of storing the planning points output from the trajectory generator 73, and outputting the stored planning points to the planning point selector 74 and the trajectory generator 73 as the preceding planning points in the next computation period.

The trajectory extractor 76 has functions of extracting a plurality of planning points from the planning points output from the trajectory generator 73, and outputting the planning points as a traveling trajectory to the vehicle controller 80. Methods of extracting the planning points are not particularly limited. Examples of the methods include a method of determining a planning point that is the closest to a target reaching point obtained from the target setting unit 60 to be a terminal planning point, and determining, to be a traveling trajectory, a sequence of points without no branch that are obtained by tracing planning points before the terminal planning point.

It is also possible to determine planning points whose distances from the target reaching point are shorter than or equal to a predetermined distance as terminal-planning point candidates and determine, to be a terminal planning point, a planning point whose cost is the lowest among the terminal-planning point candidates. Here, the cost of each of the terminal-planning point candidates is obtained by, for example, calculating a sum of products of vehicle state quantities and preset weights on respective planning points routed when planning points before the terminal-planning point candidate are traced. The planning point with the lowest sum is determined to be a terminal planning point. If setting a smaller weight to the vehicle state quantity on the riding comfort reduces the cost, the riding comfort will be improved.

Incorporation of a probability of collision with an obstacle into the vehicle state quantity at each planning point enables selection of a planning point in consideration of the probability of collision with the obstacle. The time information can be assigned to each planning point so that planning points from a preset target reaching time to a predetermined time can be determined to be the terminal-planning point candidates.

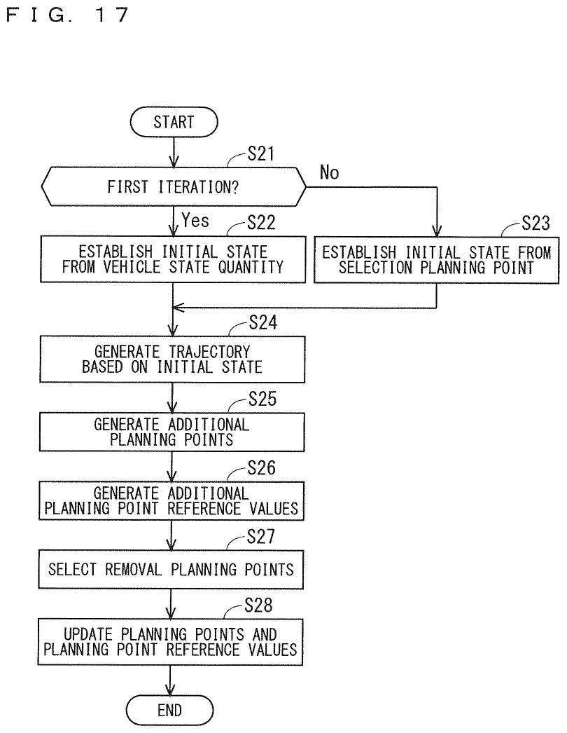

FIG. 17 is a flowchart illustrating a procedure for computing planning point reference values by the trajectory generator 73. Once starting operations, the trajectory generator 73 first determines whether the number of iterations of the computation for generating a trajectory by the traveling trajectory generating apparatus 70A is the first iteration since the start of the traveling trajectory generating apparatus 70A (Step S21). When the number of iterations is the first iteration (Yes), the processes proceed to Step S22. Otherwise (No), the processes proceed to Step S23.

In Step S22, an initial state, that is, an initial value for generating a trajectory is determined based on the vehicle state quantity obtained from the information obtaining unit 50. Then, the processes proceed to Step S24.

On the other hand, the initial state for generating a trajectory is determined from a selection planning point in Step S23. Specifically, a planning point corresponding to the selection planning point number obtained from the planning point selector 74 is extracted from the preceding planning points obtained from the planning point storage 75. A vehicle state quantity at the extracted planning point is determined to be an initial state, that is, an initial value. Then, the processes proceed to Step S24.

In Step S24, a traveling trajectory is generated by performing state estimation computation on the vehicle state quantity, based on the initial state determined in Step S22 or S23, for example, using the vehicle model disclosed in WO2020/129208. Specifically, the traveling trajectory is generated by the technology disclosed in the aforementioned known document, by determining information obtained from the planning point corresponding to the selection planning point number from among the preceding planning points to be an initial state, using the passage points and the speeds that are included in the reference values. For example, a method of generating a traveling trajectory using the obstacle information and the road information is a known method as a method of generating a traveling trajectory using the traveling information.

After the traveling trajectory is generated, the processes proceed to Step S25 where an identification number unique to each of the planning points forming the traveling trajectory is defined. Then, the identification number of each of the planning points and identification numbers of a parent and a child of the planning point are assigned to information on the planning point. Then, the planning points are determined to be additional planning points.

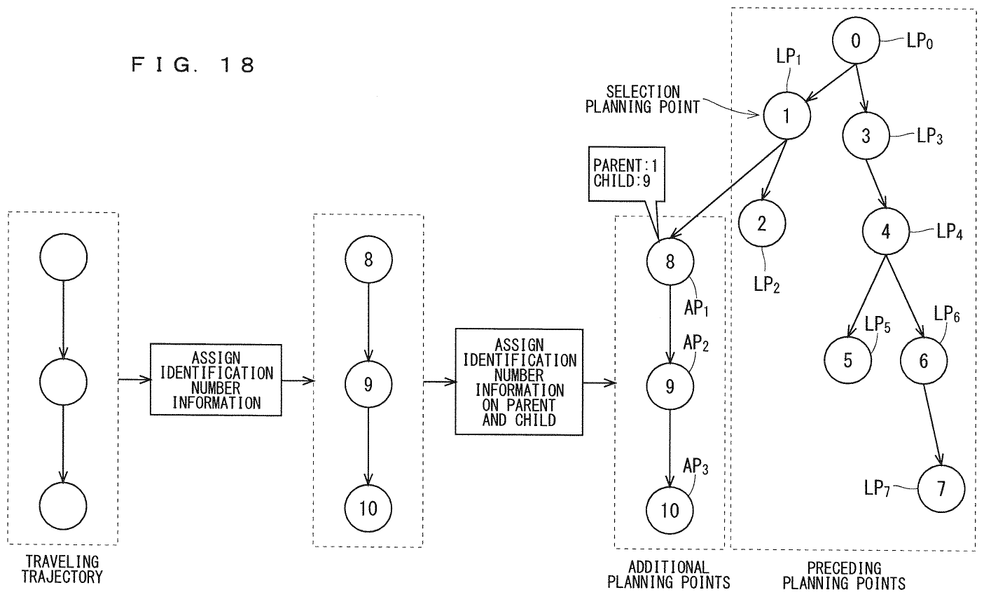

FIG. 18 illustrates a concept of this process. As illustrated in FIG. 18, when the traveling trajectory generated in Step S24 include three planning points, identification numbers, that is, identification numbers 8, 9, and 10 herein are assigned to the respective planning points. Then, the planning points to each of which identification number information on a parent and a child is assigned are determined to be additional planning points. FIG. 18 illustrates that the planning point with the identification number 8 is determined to be an additional planning point AP₁, and an additional planning point AP₂ with the identification number 9 is determined to be a child of the additional planning point AP₁ as identification number information on the parent and the child. Here, since the parent for the additional planning point AP₁ is the preceding planning point LP₁ to which the identification number 1 has been assigned, 1 is assigned to the additional planning point AP₁ as identification number information on the parent. The identification number information on the parent and the child for the additional planning points AP₂ and AP₃ is omitted.

The preceding planning point LP₁ is a selection planning point selected by the planning point selector 74 from among the preceding planning points LP₁ to LP₇ stored in the planning point storage 75. The identification numbers 1 to 7 are assigned to the preceding planning points LP₁ to LP₇.

Here, when a planning point the closest to the parent in the traveling trajectory generated in Step S24 and including the three planning points matches the selection planning point, the planning point the closest to the parent is removed from the additional planning points. Then, the selection planning point is selected as a parent of the additional planning point that is the second closest to the parent.

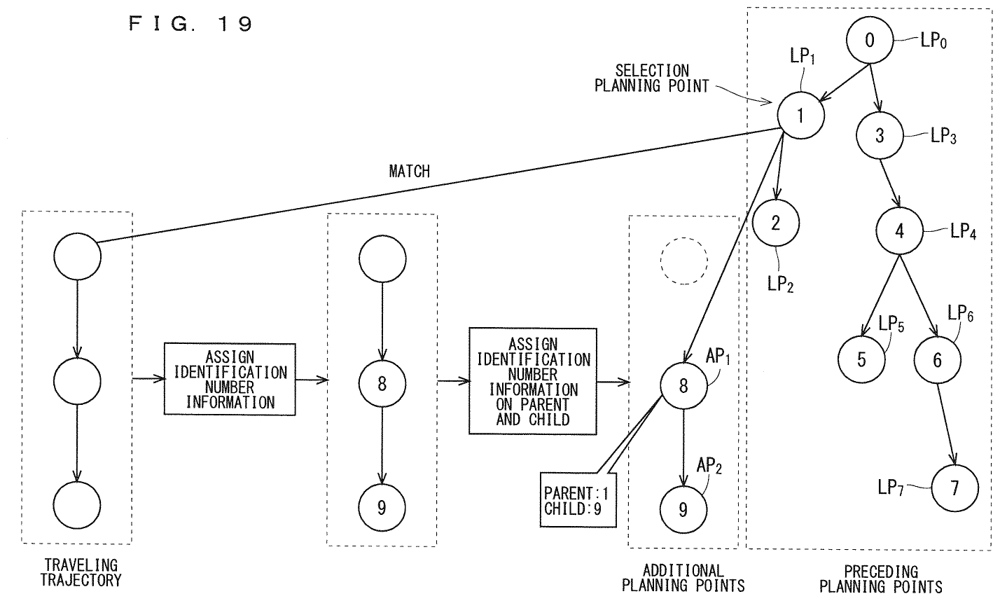

FIG. 19 illustrates a concept of this process. As illustrated in FIG. 19, when the planning point the closest to the parent in the traveling trajectory generated in Step S24 and including the three planning points, that is, the planning point at the top of the traveling trajectory matches the preceding planning point LP₁ that is the selection planning point, no identification number is assigned to this planning point, and the identification numbers 8 and 9 are assigned to the second and third planning points. FIG. 19 illustrates that the planning point with the identification number 8 is determined to be the additional planning point AP₁, the additional planning point AP₂ with the identification number 9 is determined to be the child of the additional planning point AP₁, and the preceding planning point LP₁ that is the selection planning point is determined to be the parent of the additional planning point AP₁.

After the additional planning points are generated, the processes proceed to Step S26 where planning point reference values corresponding to the additional planning points are calculated as additional planning point reference values, based on the reference values and the additional planning points.

The planning point reference values can be obtained by assigning an identification number of each of the planning points to a reference value. Examples of the planning point reference values can include a value obtained by extracting only the nearest data of a planning point or a value obtained through data interpolation, on reference values represented by a data sequence. This can reduce a usage rate of the reference value storage 72.

After the additional planning point reference values are generated, the processes proceed to Step S27 where unnecessary planning points are selected as removal planning points. Methods of selecting unnecessary planning points are not particularly limited. For example, a planning point located behind when viewed from the subject vehicle position, and a previous planning point with respect to the current time can be selected. When planning points from which the removal planning points have been removed are divided into a plurality of tree structures, one of the plurality of tree structures may be selected and planning points included in the other tree structures may be determined to be removal planning points. How to select a tree structure may be any. For example, a tree structure including planning points the closest to the subject vehicle position can be selected.

After the removal planning points are selected, the processes proceed to Step S28 where the planning points and the planning point reference values are updated. Specifically, removing the removal planning points from the preceding planning points, and adding additional planning points to the resulting planning points produce the current planning points.

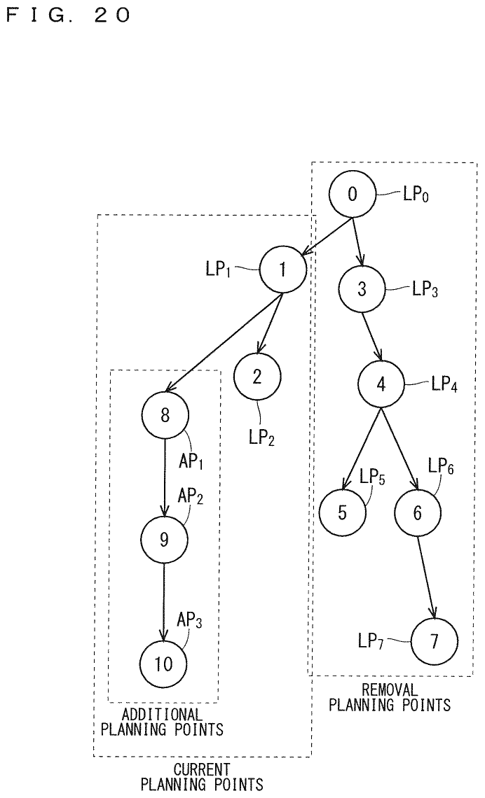

FIG. 20 illustrates a concept of this process. Assuming a preceding planning point LP₀ as a removal planning point because of being located behind the subject vehicle position in FIG. 20, the remaining planning points are completely separated into planning points subsequent to the preceding planning point LP₁ and planning points subsequent to the preceding planning point LP₃. Assuming the preceding planning point LP₁ as being the closest to the subject vehicle position among the planning points, the preceding planning points LP₃ to LP₇ are determined to be removal planning points. Then, adding additional planning points AP₁ to AP₃ to the preceding planning points LP₁ and LP₂ produces the current planning points.

In Step S28, a reference value corresponding to each of the planning points of the current planning points is extracted from the preceding planning point reference values and the additional planning point reference values, and the extracted reference values are determined to be current planning point reference values.

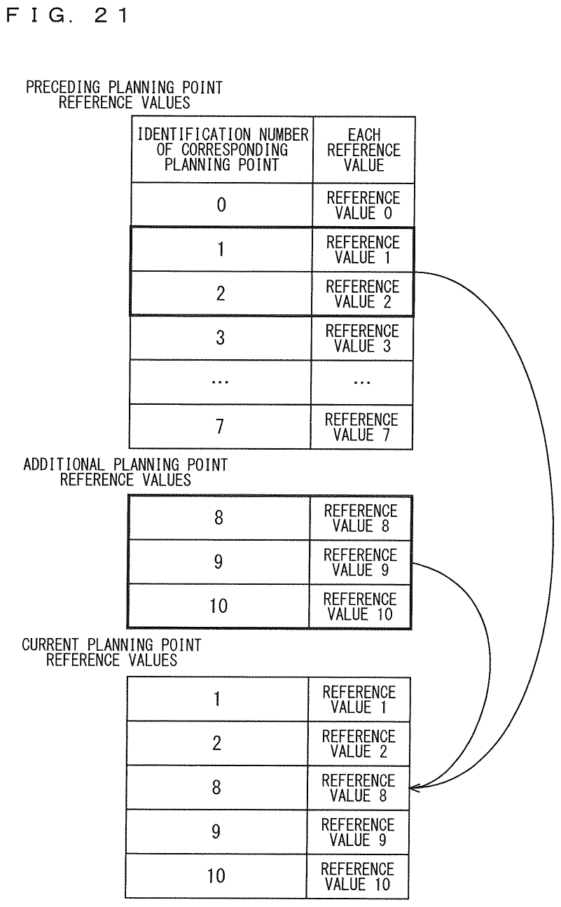

FIG. 21 illustrates a concept of this process. FIG. 21 illustrates respective tables of the preceding planning point reference values, the additional planning point reference values, and the current planning point reference values. The tables indicate reference values one-to-one with the identification numbers of the corresponding planning points. The identification numbers in FIG. 21 correspond to the identification numbers in FIG. 20. As illustrated in FIG. 21, reference values 1 and 2 of the planning points to which the identification numbers 1 and 2 are assigned are extracted from the preceding planning point reference values, and reference values 8 to 10 of the planning points to which the identification numbers 8 to 10 are assigned are extracted from the additional planning point reference values. The extracted reference values are determined to be the current planning point reference values.

The traveling trajectory generating apparatus 70A ends a series of trajectory generating processes through the processes in Steps S21 to S28, and repeats the processes in Steps S21 to S28 to generate the next trajectory.

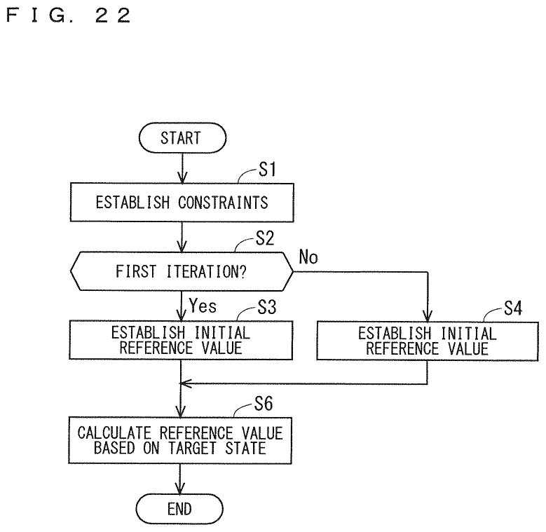

FIG. 22 is a flowchart illustrating a procedure for computing a reference value by the reference value calculator 71. The procedure of the computation of the reference value is basically the same as that performed by the reference value calculator 71 of the automated driving system 100 according to Embodiment 1 and described with reference to FIG. 5. Since processes in Steps S1, S2, S3, and S6 are the same as those in FIG. 5, the overlapping description is omitted.

In Step S2, when it is determined that the number of iterations of the computation for generating a trajectory by the traveling trajectory generating apparatus 70A is not the first iteration since the start of the traveling trajectory generating apparatus 70A (No), the processes proceed to Step S7.

In S7, a reference value corresponding to the selection planning point is extracted from the preceding planning point reference values output from the reference value storage 72. A reference value is determined based on the extracted planning point reference value, and is determined to be an initial reference value. As previously descried, a planning point reference value is a reference value to which an identification number of each planning point is assigned. Thus, removing the identification number information of each planning point from the planning point reference value can produce the reference value.

After the initial reference value is established in Step S3 or Step S7, the processes proceed to Step S6 where a new reference value is calculated based on the constraints established in Step S2, the initial reference value established in Step S3 or Step S7, and the target state obtained from the target setting unit 60. This process is identical to that according to Embodiment 1.

As described above, since the traveling trajectory generating apparatus 70A reuses the traveling trajectory generated in the past, the computation efficiency can be improved. Furthermore, selecting a traveling trajectory with the cost being set from those in the branching planning points can produce the traveling trajectory with better riding comfort. Incorporation of a probability of collision with an obstacle into the vehicle state quantity of each planning point can increase a probability of generating a traveling trajectory with a low probability of collision with an obstacle.

### [Hardware Configuration]

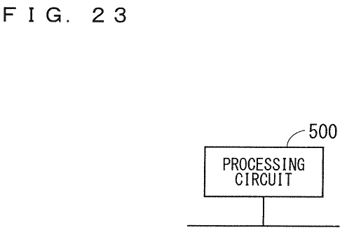

Each of the aforementioned constituent elements of the traveling trajectory generating apparatuses 70 and 70A according to Embodiments 1 and 2 can be configured using a computer, and is implemented by causing the computer to execute a program. Specifically, each of the traveling trajectory generating apparatuses 70 and 70A is implemented by, for example, a processing circuit 500 illustrated in FIG. 23. A processor such as a central processing unit (CPU) or a digital signal processor (DSP) is applied to the processing circuit 500. The processing circuit 500 causes a program stored in a storage to implement functions of each of the constituent elements.

This processing circuit 500 may be dedicated hardware. When the processing circuit 500 is dedicated hardware, it corresponds to, for example, a single circuit, a composite circuit, a programmed processor, a parallel-programmed processor, an application-specific integrated circuit (ASIC), a field-programmable gate array (FPGA), or any combination of these.

Each function of the constituent elements of the traveling trajectory generating apparatuses 70 and 70A may be implemented by a separate processing circuit, or the functions may be collectively implemented by a single processing circuit.

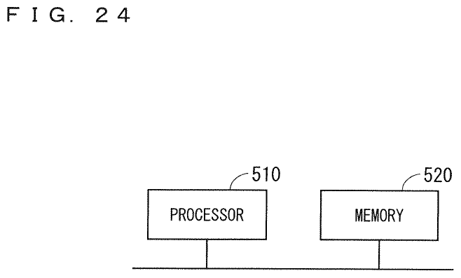

FIG. 24 illustrates a hardware configuration when the processing circuit 500 includes a processor. The functions of each of the constituent elements of the traveling trajectory generating apparatuses 70 and 70A are implemented by any combinations with software (software, firmware, or the software and the firmware). For example, the software is described as a program, and is stored in a memory 520. A processor 510 functioning as the processing circuit 500 performs the functions of each of the constituent elements by reading and executing the programs stored in the memory 520 (a storage). Put it differently, this program causes a computer to execute procedures and methods of operations of the constituent elements of the traveling trajectory generating apparatuses 70 and 70A.

Here, examples of the memory 520 include a non-volatile or volatile semiconductor memory such as RAM, ROM, a flash memory, an erasable programmable read-only memory (EPROM), and an electrically erasable programmable read-only memory (EEPROM), hard disk drive (HDD), a magnetic disk, a flexible disk, an optical disk, a compact disc, a MiniDisc, a Digital Versatile Disc (DVD), a drive device thereof, and further any storage medium to be used in the future.

What is described is a configuration for implementing the functions of each of the constituent elements of the traveling trajectory generating apparatuses 70 and 70A by one of hardware and software, for example. However, the configuration is not limited to this but a part of the constituent elements of the traveling trajectory generating apparatuses 70 and 70A may be implemented by dedicated hardware, and another part of the constituent elements may be implemented by software, etc. For example, the processing circuit 500 functioning as the dedicated hardware can implement the functions of the part of the constituent elements, and the processing circuit 500 functioning as the processor 510 can implement the functions of the other part of the constituent elements through reading and executing a program stored in the memory 520.

As described above, the traveling trajectory generating apparatuses 70 and 70A can implement each of the functions by hardware, software, etc., or any combinations of these.

While the present disclosure is described in detail, the foregoing description is in all aspects illustrative and does not restrict the present disclosure. Therefore, numerous modifications and variations that have not yet been exemplified can be devised without departing from the scope of the present disclosure.

Embodiments can be freely combined or appropriately modified and omitted within the scope of the disclosure.

1. (canceled)

2. A traveling trajectory generating apparatus that generates a traveling trajectory of a vehicle, the traveling trajectory generating apparatus comprising:
a planning point storage to store a plurality of preceding planning points used when the traveling trajectory generating apparatus has generated the traveling trajectory in a preceding computation period;
a planning point selector to select one planning point as a selection planning point from among the plurality of preceding planning points stored in the planning point storage, and determine the selection planning point to be an initial value when the traveling trajectory generating apparatus generates the traveling trajectory;
a reference value calculator to calculate a plurality of current reference values, based on at least the selection planning point and a target state that is a target value of a vehicle state quantity of the vehicle, the plurality of current reference values being referred to when the traveling trajectory generating apparatus generates the traveling trajectory in a current computation period; and
a trajectory generator to generate a plurality of current planning points, based on the plurality of current reference values calculated by the reference value calculator, the plurality of preceding planning points, and the selection planning point, and generate the traveling trajectory from at least one current planning point extracted from the plurality of current planning points.

3. The traveling trajectory generating apparatus according to claim 2,
wherein the target value of at least one of a speed, an acceleration, a steering angle, a steering angular velocity, a rotation speed, an orientation, a lateral deviation with respect to a center of a following lane, or the following lane of the vehicle is defined as the target state.

4. The traveling trajectory generating apparatus according to claim 3,
wherein the target value of a target following lane is defined as the target state,
the plurality of reference values include a following lane number, a lane transition rate representing a degree of transition from a current following lane to the target following lane, and a passage point, and
the reference value calculator calculates the passage point, based on the target state, and the following lane number and the lane transition rate that are included in the plurality of reference values.

5. The traveling trajectory generating apparatus according to claim 3,
wherein the reference value calculator establishes a constraint defining a range of possible values of a part of a variable included in the target state, and calculates the plurality of current reference values under the constraint.

6. The traveling trajectory generating apparatus according to claim 5,
wherein the variable is at least one of the speed, the acceleration, a jerk, the steering angle, the steering angular velocity, a steering angle acceleration, the rotation speed, a rotation acceleration, a vehicle sideslip angle, or a lane change time of the vehicle.

7. The traveling trajectory generating apparatus according to claim 5,
wherein the target state includes emergency, and
the reference value calculator changes the constraint according to the emergency.

8. The traveling trajectory generating apparatus according to claim 4,
wherein the plurality of reference values include a reference lateral deviation representing a lateral deviation that the vehicle should take with respect to a reference passage point, and
the reference value calculator determines the reference lateral deviation according to a position of an obstacle.
